(19) United States
(12) Patent Application Publication
(10) Pub. No.: US 2005/0197877 A1
(43) Pub. Date: Sep. 8, 2005

(54) System and method for scheduling heterogeneous resources

(76) Inventor: Ken Kalinoski, Austin, TX (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/795,893

(22) Filed: Mar. 8, 2004

(51) Int. Cl. G06F 17/60

(52) U.S. Cl. 705/8

(57) ABSTRACT

Heterogeneous resources, such as video conference, audio conference, network, conference room and catering resources, are scheduled through a uniform interface to satisfy a meeting organizer's constraints to have a properly configured meeting with selected of the heterogeneous resources. A prioritized list of sets of heterogeneous resources is determined for scheduling of a selected set, such as the set having the least estimated cost. Automated scheduling tracks resource availability, restricts access to predetermined resources, ensures that rescheduling results in a proper configuration, notifies attendees in an individualized manner, and initiates resource use according to the schedule.

### BACKGROUND OF THE INVENTION

1. Field of the Invention

The present invention relates in general to the field of scheduling resources, and more particularly to a system and method of scheduling heterogeneous networked resources.

2. Description of the Related Art

Businesses and organizations have invested substantially in a variety of communication media to improve worker efficiency, such as by reducing travel time and increasing the exchange of relevant information between workers. Some examples of the types of resources available include video conferencing resources, audio conferencing resources, network resources, instant messaging sessions, e-mail, application-sharing or “web conferencing” sessions and other bandwidth-intensive activities, building space resources such as conference rooms, and a variety of other support services like catering support and information technology professionals to coordinate resource scheduling and usage. Although these various communication media aid in the exchange of information, their efficient use is often difficult to coordinate. For instance, a meeting organizer coordinating a meeting between multiple attendees and multiple locations may have to obtain for each of the locations communication resources, such as video or audio conferencing equipment, seating arrangements, a whiteboard for notes, shared application resources to exchange the notes and a catered lunch. Generally, the meeting organizer must arrange each resource and service separately. In addition, the meeting organizer typically must ensure that the resources are available and have notibeen scheduled for another meeting. Once the meeting is set and resources arranged, the meeting organizer often has to track changes in the schedule of the meeting or the attendees and re-schedule all appropriate resources. Failure to correctly schedule resources for a meeting can lead to failure of the meeting, such as due to the unavailability of video equipment. Additionally, incorrect or over-scheduling of resources means that others who could use the resources are unable to do so.

A number of conventional solutions are available to aid in the scheduling of resources with each solution typically focused only on specific resources, such as individuals, video resources, audio resources or conference room resources. Thus, for instance, conventional solutions for scheduling communication devices, such as video conferencing resources, track the devices that support a conference but typically have no information regarding the individuals involved in the conference. The result of the disparate conventional solutions is that a meeting organizer has to be familiar with and use multiple systems to schedule meetings and events. The use of multiple scheduling systems introduces complexity into the scheduling process and discourages a meeting organizer from utilizing all available resources. Where a meeting organizer does use resources scheduled through disparate scheduling systems, the meeting organizer often must flip between the different scheduling systems to locate coinciding available times. After the resources are scheduled, any changes to the timing or nature of the scheduled meetings typically means that the meeting organizer must return to each resource scheduling system to alter the times scheduled for the resources. With complex meetings that involve a large number of resources, a meeting organizer can easily forget to reschedule one or more resources. For instance, a meeting organizer who changes a breakfast meeting to a lunch meeting by accessing the participant's Microsoft Outlook schedules will also have to contact the catering service separately to change the doughnut order into a sandwich plate. Failure to do so could result in an order of doughnuts delivered to an empty meeting room and a hungry lunch crowd wondering about the stale doughnuts left on the meeting room table.

### SUMMARY OF THE INVENTION

Therefore a need has arisen for a system and method which schedules heterogeneous networked resources through a unified interface.

In accordance with the present invention, a system and method are provided which substantially reduce the disadvantages and problems associated with previous methods and systems for scheduling heterogeneous resources. A unified interface accepts scheduling constraints and applies the constraints to properties of the heterogeneous resources to determined prioritized valid configurations.

More specifically, a configuration engine applies scheduling constraints to resource properties to order sets of validly configured heterogeneous resources for selection to support a scheduled meeting. Optional selection of a set of resources is available automatically by lowest projected cost, manually from an order that approximates cost or by biasing a cost calculation to adjust the weight provided by one or more scheduling constraints. An availability engine monitors resource availability to preclude unauthorized double-booking of resources and allow selection of a resource that becomes open subsequent to the initial scheduling. An access controller restricts use of one or more resources to authorized parameters and a reschedule engine supports rescheduling of events to meet the constraints with a valid configuration. A notification engine provides selective notification of scheduled events to administrators and attendees and a resource engine initiates, monitors and terminates resource use according to the selected schedule.

The present invention provides a number of important technical advantages. One example of an important technical advantage is that a single comprehensive interface schedules and configures heterogeneous resources through a client-server architecture. A meeting organizer schedules all types of resources through a single interface without having to flip between different applications. The availability of all resources through a single interface simplifies the scheduling process by providing a more uniform display of scheduling options and reducing the likelihood that a meeting organizer will forget about the availability of a resource. Further, a complete picture of scheduled resources is readily available so that changes to the timing or nature of a scheduled event will be coordinated through a single interface for all of the resources of that event. Media resource service providers are more easily managed by network administration with reduced impact on users due to, for instance, retraining with the new service or scheduling desktop applications related to a new service.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a heterogeneous resource scheduling system; and

FIG. 2 depicts a block diagram of a process for scheduling heterogeneous resources.

### DETAILED DESCRIPTION

The conveniences of modem communications technology improves access to information but often does so with a corresponding cost in complexity. Meeting organizers face scheduling and configuration issues related to numerous heterogeneous resources ranging from expensive video endpoints to the mysterious inner workings of a conference call, such as MCU, gateway and bridge devices. In addition, meeting organizers often deal with a myriad of details ranging from the physical assets needed to make the meeting work, like location, seating, whiteboards, handouts, coffee, etc. . . . , to the attendees of meeting. To aid in coordinating meetings, a client-server or web server architecture centralizes scheduling of heterogeneous resources with a heterogeneous resource scheduler accessed through a user interface. Client user interfaces that access the scheduler include browsers or plug-ins to conventional calendar systems, such as Lotus Notes or Microsoft Outlook. The heterogeneous resource scheduler communicates with clients and the various resources, such as media systems and services, to reduce the complexity of scheduling a meeting and the desired resources for making the meeting happen.

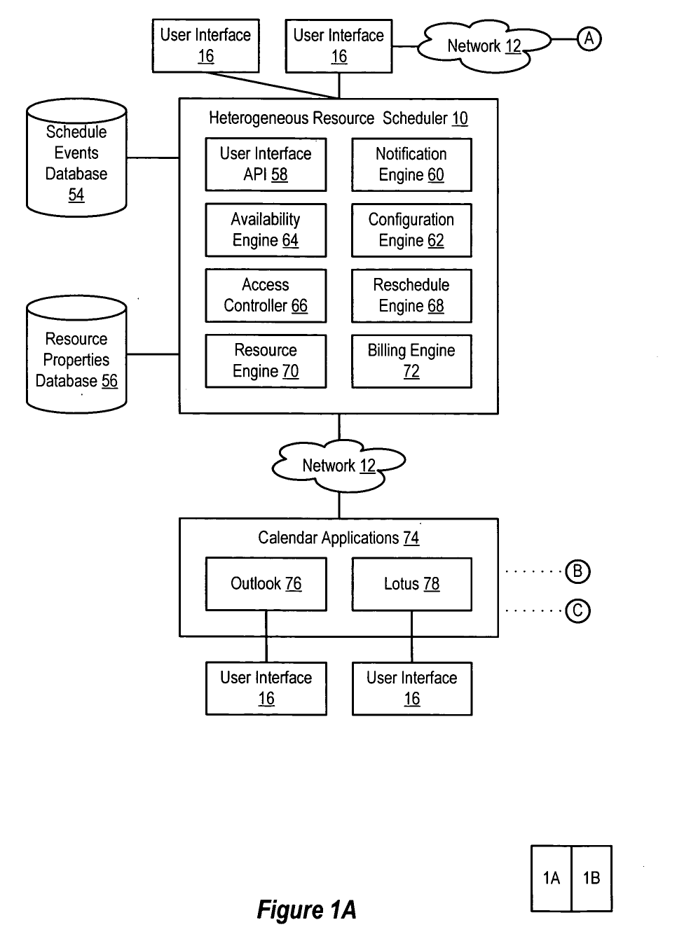

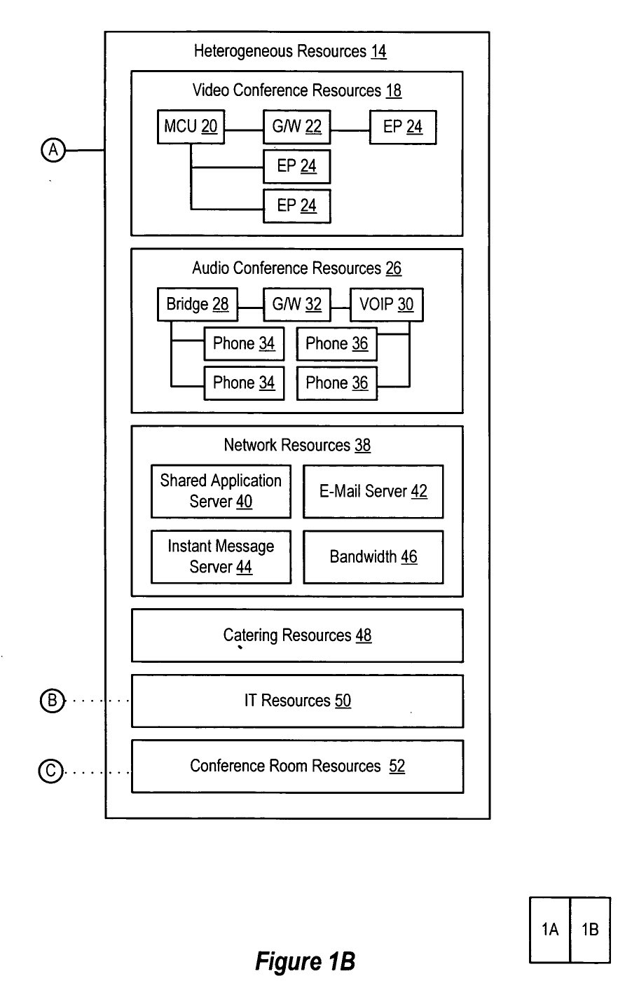

Referring now to FIG. 1, a block diagram depicts a heterogeneous resource scheduler 10 interfaced through a network 12 with heterogeneous resources 14 that support meetings and with user interfaces 16 that support the scheduling of meetings with heterogeneous resources 14. Heterogeneous resources 14 include video conference resources 18, audio conference resources 26, network resources 38, catering resources 48, information technology resources 50 and conference room resources 52. Video conference resources 18 include MCU 20, gateway 22 and endpoint 24 devices that support videoconferencing between distal locations. Audio conference resources 26 include bridges 28, Voice over Internet Protocol (“VoIP”) servers 30, gateways 32, conventional phones 34 and VoIP phones 36. Network resources 38 included shared application server 40 that allows display at distal locations of an application, such as Powerpoint, e-mail server 42, instant message server 44 and network bandwidth 46. Heterogeneous resources 14 may include internal resources available to a business or external resources purchased as a service from third parties. For instance, audio bridges 28 are available from a number of telephone companies through dial-up numbers and catering services are available from outside dining services. In addition, other types of heterogeneous resources may be included based on the needs of scheduled or anticipated meetings.

Heterogeneous resources scheduler 10 tracks use, availability and characteristics of heterogeneous resources 14 with a scheduled events database 54 and resource properties database 56. User interfaces 16 access and manage the availabilities and properties of heterogeneous resources 14 in schedule events database 54 and resource properties database 56 respectively with user interface API 58 of heterogeneous resource scheduler 10. For instance, user interface API 58 supports interactions through Web-based protocols accessible by a conventional browser user interface 16 or through a plug-in user interface 16 associated with conventional calendar applications 74, such as Outlook 76 or Lotus Notes 78. A notification engine 60 also interfaces with user interfaces 16 to report scheduled events to appropriate individuals, such as attendees of a meeting or administrators of heterogeneous resources. Notification engine 60 automatically provides notices and updates with a rules-based approach that allows selective review of notice parameters by the meeting organizer, such as the medium and timing of communicating notices, with the type of information and the degree of automation determined from notice parameters associated with the scheduled assets. For instance, e-mail, paging and/or phone call notices are associated with attendees for initial and/or reminder notices based on properties individually pre-selected by attendees and stored in resources properties database 18 or calendar applications 74. In addition, a meeting organizer may select a telephone reminder for a particularly forgetful attendee that is generated to a cell phone minutes before the meeting by a text-to-speech computer synthesized message.

Scheduled events are established and stored in scheduled events database 54 through interactions between a configuration engine 62, an availability engine 64 and an access controller 66 that obtain resource properties from database 56. The resource properties are extensible and reviewed through user interface 16 for scheduled event specific adjustments. For instance, conference rooms have associated capacity, location, phone numbers, available equipment, furnishings and usage fees that a meeting organizer is allowed to selectively constrain, such as by reducing the capacity of selected conference rooms and artificially increasing the number of attendees to increase the minimum capacity acceptable for a scheduled conference room. A meeting organizer selects an event and constraints for the event through user interface 16, and provides the constraints to configuration engine 62 to initiate the scheduling of an event that meets the constraints. User interface API 58 manages user requests to configuration engine 62 for the creating, editing, deleting and finding of events, resources and administrative controls. For example, a meeting organizer requests a meeting at a specific time or in a defined time period with a video conference between two distal locations. Other examples of constraints for the meeting include a request for equipment, such as a projector, IT assistance, such as with operation of the projector, catering, such as coffee and doughnuts, conference room characteristics, such as security and capacity, or other extensible constraints.

Configuration engine 62 associates the requested constraints with candidate resources through application of resource parameters to priority rules, and orders the candidate resources according to the satisfaction by each as defined by the associated parameters of the constraints and rules. In one embodiment, ordering reflects relative and/or absolute cost based on an abstraction or model of the relationship of constraints and parameters. User preferences may additionally reflect the cost estimation used for prioritizing resources by placing relative value on selected parameters. For instance, a user may select “the sooner the better” to place greater importance to timeliness, “economize room capacity” to decrease importance to room size, and “the closer the better” to increase importance to locality. Plural dimensions of such user preferences may be aggregated into a single cost function for ordering, such as by assignment of numerical values from 1 to 10 with unbounded constraints bounded and normalized by dividing the maximum value of 10 by a function of the logarithm of the quantity and summing the normalized costs to form a single aggregate cost for minimization. In addition to its prioritizing function, configuration engine 62 ensures that a proper configuration of resources is considered for scheduling. For instance, if a videoconference or audio conference is requested, configuration engine 62 ensures that adequate MCU or bridge resources are available to join the anticipated participants.

Once configuration engine 62 has identified and prioritized resources having parameters to meet the desired constraints and applicable rules, availability engine 64 determines resource availability and presents the user with selections from an ordered list based on the determined priorities. If the user indicates a selection, availability engine 64 reserves the selected resources for the selected times in scheduled events database 54 to prevent double-booking of designated resources. The priority list may include some resources that are unavailable due to an existing reservation or that allow multiple bookings. Availability engine 64 indicates if multiple reservations are allowed and provides the user with monitoring of future availability of a resource to determine if a user request for a resource can be filled. Availability engine 64 notifies an event organizer once a resource becomes available or, in some cases, automatically schedules the resources and notifies event attendees of the change.

Selection by a user of a resource or set of resources is also monitored by access controller 66 to ensure that a restricted resource or set of resources are used in an authorized manner. For instance, access controller monitors an action parameter associated with each resource to approve resource scheduling. For instance, an action parameter associated with a MCU at a given location restricts scheduling of that MCU to video conferences involving attendees at the location. As another example, cost restrictions apply to events based on the level of approval of an event within an organization. Thus, a staff meeting might have authorization to order small snacks while an executive meeting has authorization to have a full service meal. In addition, access controller 66 authorizes the overriding of scheduled events to bump resources for higher priority events, such as by the organizational seniority of attendees, the locality of the meeting versus the locality of the resources, and nature of the meeting. In the event that a scheduled event has resources bumped, a reschedule engine 68 determines the best alternative resource or set of resources for the event based on the meeting organizer's original request and the available resources and notifies the meeting organizer of the need to reschedule. Notification engine 60 provides notice to attendees of rescheduled events.

A resource engine 70 monitors scheduled events and, if desired, initiates requested services at appropriate times. For instance, resource engine 70 communicates to video conference resources 18 to have a scheduled MCU 20 initiated dialing to scheduled endpoints 24. Resource engine 70 monitors scheduled resources during the event to detect failures, gather statistics, obtain intervention of IT resources where necessary and terminate the resources at the end of the event. Resource engine 70 maintains records of event resource usage with a conference detail record that covers all resources in a unified report. For example, information tracked by resource engine 70 includes resource utilization, daily schedulers per attendee, daily schedules per resource, fee reports, catering, room usage, equipment usage and services. Resource usage is provided to billing engine 72 which provides integrated billing for resource and service usage and exports report information for accounting purposes to external spreadsheets, databases and enterprise resource planning systems.

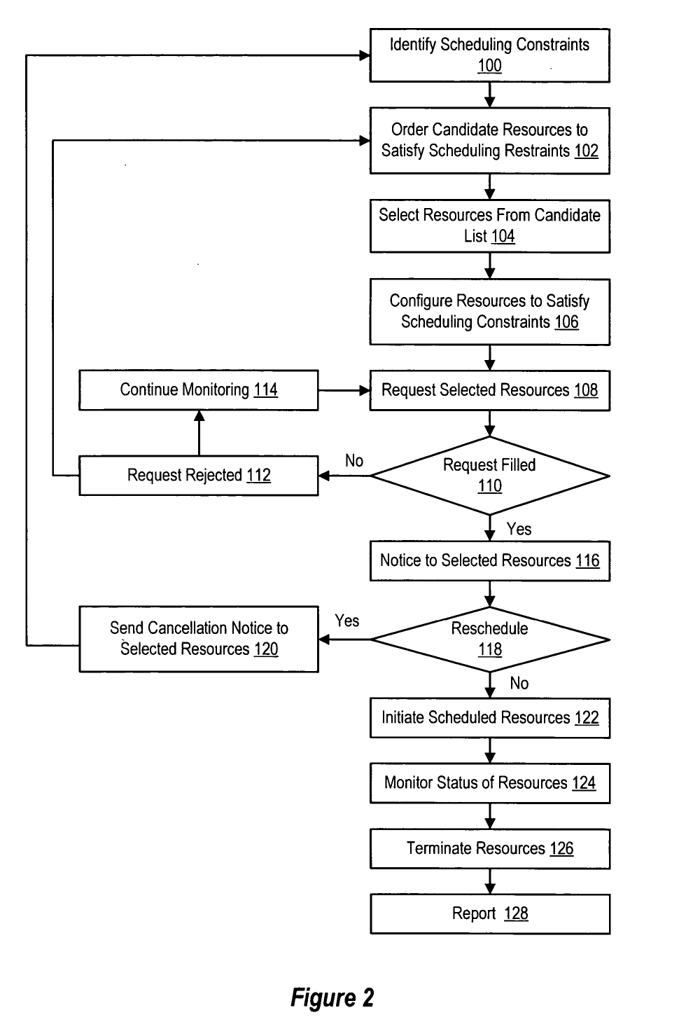

Referring now to FIG. 2, a flow diagram depicts a process for scheduling heterogeneous resources in support of an event. The process begins at step 100 with the identification of scheduling constraints, such as the number and location of attendees and the type of communication medium desired. At step 102, candidate resources that satisfy the scheduling constraints are ordered by priority from greatest degree of satisfaction to least degree of satisfaction, such as from least to greatest cost. The candidate resources are presented as an ordered list of sets of heterogeneous resources with each set having a valid configuration that satisfies the constraints. Note that sufficiently restrictive constraints may limit the candidate list to one or even zero elements. At step 104, resources are selected from the candidate list for scheduling the event. At step 106, the resources selected to satisfy the scheduling constraints are configured to ensure an operable event, such as by the scheduling of adequate bridge, gateway and MCU devices. At step 108, a request is made to reserve the selected resources and at step 110, the filling of the request is confirmed. If the request is not confirmed, the process continues to step 112 to determine if the requested resource was finally rejected or placed on hold. Finally rejected requests return to step 102 for another attempt to reschedule while requests that are placed on hold proceed to step 114 for monitoring and back to step 108 to have the request repeated as necessary.

Once an event request is filled at step 110, the process continues to step 116 for the sending of notices to the attendees and to individuals associated with scheduled resources, such as network administrators. At step 118, a determination is made of whether to reschedule an event. Rescheduling proceeds through step 120 for the sending of cancellation notices to selected resources as necessary and then returns to step 100 to identify the new scheduling restraints. If no rescheduling occurs, the process continues to step 122 for initiation of the scheduled resources at the scheduled time and then to step 124 for monitoring of the scheduled resources during use. At step 126 the event is terminated, such as when the scheduled use of resources is complete or the current use overlaps with another scheduled use. At step 128 reports for resource use are prepared for planning and billing purposes.

Although the present invention has been described in detail, it should be understood that various changes, substitutions and alterations can be made hereto without departing from the spirit and scope of the invention as defined by the appended claims.

1. A system for scheduling meetings using plural heterogeneous resources, the system comprising:
a user interface operable to accept meeting constraints;
a resource properties database having plural heterogeneous resources, each resource having associated properties;
a scheduled events database storing schedules for the heterogeneous resources;
a configuration engine interfaced with the user interface and resource properties database, the configuration engine operable to apply the meeting constraints and the resource properties to priority rules that generate an ordered list of heterogeneous resource sets, each set having a valid configuration that satisfies the meeting constraints; and
an availability engine interfaced with the configuration engine and the scheduled events database, the availability engine operable to select heterogeneous resources from the ordered list based on the scheduled availability of the resources.

2. The system of claim 1 wherein the configuration engine is further operable to order the list of heterogeneous resources according to a cost function, the list ordered with the greatest priority given to the set of heterogeneous resources having the least cost to satisfy the meeting constraints.

3. The system of claim 2 wherein the configuration engine cost function adjusts to user-selected weights for one or more meeting constraints.

4. The system of claim 3 wherein the user-selected weights comprise one or more of meeting timing, capacity and locality.

5. The system of claim 1 wherein the availability engine is further operable to:
identify resources of the priority list that are unavailable to satisfy meeting constraints due to a scheduled use; and
monitor the unavailable resources for subsequent availability to satisfy the meeting constraints.

6. The system of claim 1 further comprising an access controller interfaced with the availability engine and the resource properties database, the access controller operable to restrict scheduling of one or more resources having limited access properties.

7. The system of claim 6 wherein the limited access property comprises an authorization code to exceed a predetermined cost associated with resource use.

8. The system of claim 6 wherein the access controller is further operable to override a scheduled use of a resource to satisfy meeting constraints having a predetermined priority.

9. The system of claim 6 further comprising a reschedule engine operable to automatically reschedule overridden scheduled uses.

10. The system of claim 6 further comprising a notification engine interfaced with the availability and reschedule engines, the notification engine operable to automatically notify attendees of a meeting scheduled according to a set of resources of the ordered list and to automatically notify attendees of rescheduling.

11. The system of claim 1 further comprising a resource engine interfaced with the scheduled events database and the heterogeneous resources, the resource engine operable to initiate, terminate and track use of the heterogeneous resources in compliance with the schedule.

12. The system of claim 1 wherein the heterogeneous resources comprise at least video conference resources, audio conference resources and network resources.

13. A method for scheduling meetings using plural heterogeneous resources, the method comprising:
identifying scheduling constraints associated with the meeting;
ordering in priority a list of plural sets of candidate heterogeneous resources, each set having a valid configuration that satisfies the scheduling constraints;
selecting a set of heterogeneous resources from the ordered list;
scheduling the heterogeneous resources to support the meeting;
automatically notifying attendees of the schedule; and
automatically initiating one or more of the heterogeneous resources according to the schedule.

14. The method of claim 13 further comprising:
identifying one or more biasing weights associated with one or more scheduling constraints; and
ordering the priority list according to the biasing weights.

15. The method of claim 14 wherein ordering further comprises:
estimating a cost associated with each set of heterogeneous resources; and
providing greater priority to sets having smaller costs.

16. The method of claim 13 wherein automatically notifying attendees further comprises:
associating one or notification parameters with each attendee; and
selecting one or more notification medium for each attendee based on the notification parameters associated with the attendee.

17. The method of claim 16 wherein the notification medium comprises a telephone sending a computer generated voice reminder.

18. The method of claim 17 wherein the notification parameter comprises a predetermined quantification of user forgetfulness and the notification further comprises cell phone call within a predetermined time of the scheduled meeting.

19. The method of claim 13 further comprising limiting access to predetermined heterogeneous resources according to one or more required authorizations.

20. The method of claim 1 wherein the heterogeneous resources comprise at least video conference resources, audio conference resources and network resources.
